(19) United States
(12) Patent Application Publication
(10) Pub. No.: US 2022/0137485 A1
(43) Pub. Date: May 5, 2022

(54) Optical Signal Processing Apparatus

(71) Applicant: Nippon Telegraph and Telephone Corporation, Tokyo (JP)

(72) Inventors: Shiori Konisho, Musashino-shi, Tokyo (JP); Toshikazu Hashimoto, Musashino-shi, Tokyo (JP); Mitsumasa Nakajima, Musashino-shi, Tokyo (JP)

(21) Appl. No.: 17/431,319

(22) PCT Filed: Feb. 7, 2020
(86) PCT No.: PCT/JP2020/004955

§ 371 Date: Aug. 16, 2021

(30) Foreign Application Priority Data
Feb. 19, 2019 (JP) 2019-027369

(51) Int. Cl. G02F 3/02

(52) U.S. Cl. CPC G02F 3/02

(57) ABSTRACT

Provided is an optical signal processing apparatus capable of improving computing accuracy without increasing the number of nodes of a reservoir layer. An optical signal processing apparatus for converting an input one-dimensional signal to an optical signal to perform signal processing includes: an input unit configured to perform linear processing on the input one-dimensional signal to convert the input one-dimensional signal to an optical signal of multi-wavelength; a reservoir unit connected to an output of the input unit and configured to perform linear processing and nonlinear processing on the optical signal; and an output unit connected to an output of the reservoir unit and configured to convert the optical signal to an electrical signal and perform linear processing to output a one-dimensional output.

### TECHNICAL FIELD

The present invention relates to an optical signal processing apparatus that can be applied to optical reservoir computing.

### BACKGROUND ART

In recent years, an environment has been constructed to acquire a large amount of data from various sensors via the Internet, and research and business for analyzing the large amount of acquired data and performing highly accurate knowledge processing and future prediction have been actively carried out. In general, because analysis of a large amount of data requires time and incurs costs such as power consumption, computing devices having high speed and high efficiency are required. As a computing scheme for such information processing, an optical computing technique called reservoir computing (RC), which imitates signal processing of the cerebellum, has been proposed. Optical computing devices using a dynamical system called RC are attracting attention because such devices are likely to have both high speed and high efficiency.

In examples of applications of optical RC in the related art, examples of solving a one-dimensional input and output problem such as a chaos approximation problem and NARMA 10 have mainly been reported (for example, see Non Patent Literature 1). Further, it is necessary to improve computing accuracy in order to further widen a range of applications of optical RC.

### CITATION LIST

### Non Patent Literature

Non Patent Literature 1: L. Larger, et al., “Photonic information processing beyond Turing: an optoelectronic implementation of reservoir computing”, Optics Express Vol. 20, Issue 3, pp. 3241-3249 (2012)

### SUMMARY OF THE INVENTION

### Technical Problem

In RC, it is generally known that the computing accuracy is improved by an increase in the number of nodes of a reservoir layer. In the case of optical RC, because the nodes of the reservoir layer are represented by the number of optical pulses that circulate around a fiber ring, computing processing is performed by time-multiplexing the circulating optical pulses in order to increase the number of nodes and improve the computing accuracy. However, all of tasks and nodes are expanded on a time axis to input data, and thus the higher the number of nodes, the longer the data time to enter into the optical RC, which leads to a problem of reduced throughput.

### Means for Solving the Problem

An object of the present invention is to provide an optical signal processing device capable of improving computing accuracy without increasing the number of nodes of a reservoir layer.

In order to achieve such an object, an aspect of the present invention is an optical signal processing apparatus for converting an input one-dimensional signal to an optical signal to perform signal processing, the optical signal processing apparatus including: an input unit configured to perform linear processing on the input one-dimensional signal to convert the input one-dimensional signal to an optical signal of multi-wavelength; a reservoir unit connected to an output of the input unit and configured to perform linear processing and nonlinear processing on the optical signal; and an output unit connected to an output of the reservoir unit and configured to convert the optical signal to an electrical signal and perform linear processing to output a one-dimensional output.

### Effects of the Invention

According to the present invention, by making optical RC that expand a node in the wavelength direction instead of expanding the node in the time axis direction, the throughput of the optical RC can be improved without increasing the input time of data.

### BRIEF DESCRIPTION OF DRAWINGS

FIG. 1 is a diagram illustrating an overall configuration of an optical signal processing apparatus according to an embodiment of the present invention.

FIG. 2 is a diagram illustrating a configuration of an input unit of the optical signal processing apparatus according to the present embodiment.

FIG. 3 is a diagram illustrating a configuration of a reservoir unit of the optical signal processing apparatus according to the present embodiment.

FIG. 4 is a diagram illustrating a configuration of an output unit of the optical signal processing apparatus according to the present embodiment.

FIG. 5 is a diagram for describing an optical signal processing apparatus that uses wavelength multiplexing and time multiplexing in combination.

### DESCRIPTION OF EMBODIMENTS

Hereinafter, an embodiment of the present disclosure will be described in detail with reference to the drawings.

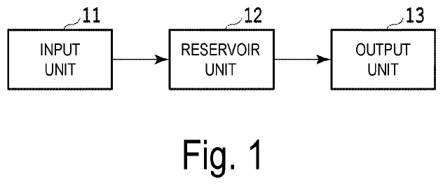

FIG. 1 illustrates an overall configuration of an optical signal processing apparatus according to an embodiment of the present invention. The optical signal processing apparatus includes an input unit 11, a reservoir unit 12, and an output unit 13. The input unit 11 performs linear processing on an input one-dimensional signal, and converts the signal to an optical signal of multi-wavelength. The reservoir unit 12 is connected to an output of the input unit 11, and performs random linear processing and nonlinear processing on a multi-wavelength signal. The output unit 13 is connected to an output of the reservoir unit 12, converts an optical signal into an electrical signal, and performs linear processing to output a one-dimensional output.

The optical signal processing apparatus of the present embodiment improves throughput of optical RC by expanding a node in the wavelength direction instead of expanding the node in the time axis direction.

Input Unit

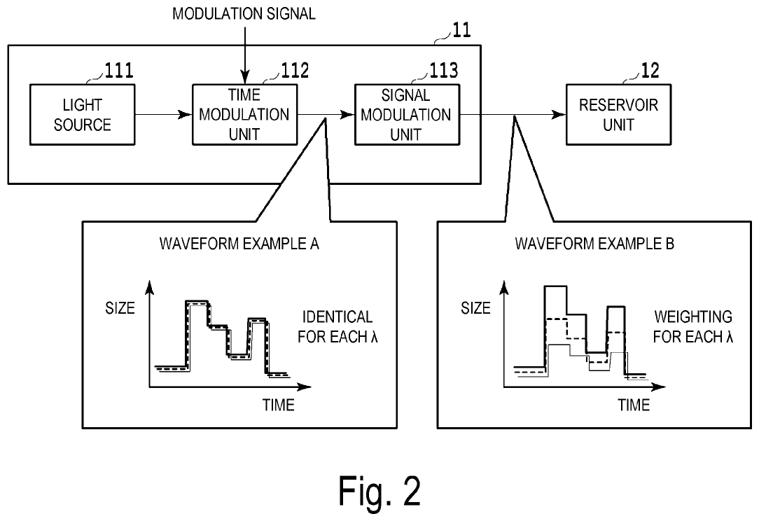

FIG. 2 illustrates a configuration of an input unit of the optical signal processing apparatus according to the present embodiment. The input unit 11 functions to propagate a multi-wavelength optical signal to the reservoir unit 12. The input unit 11 includes a multi-wavelength light source 111, a time modulation unit 112, and a signal modulation unit 113. The time modulation unit 112 modulates an optical signal from the multi-wavelength light source 111 with an electrical signal for modulation. The signal modulation unit 113 weights an output of the time modulation unit 112 for each wavelength.

As the multi-wavelength light source 111, an amplified spontaneous emission (ASE) light source, a broadband light source, a plurality of single wavelength light sources, or the like can be used. When the ASE light source is used, the light source can be operated relatively stably because only intensity information is used. When the broadband light source is used, an amount of information can be made twice or more because both intensity information and phase information are used. When the plurality of single wavelength light sources are used, intensity information and phase information can be adjusted and used for each wavelength.

The input unit 11 executes processing indicated in Equation (1).

Math. 1

xᵢₙ(λ,t)=wᵢₙ(λ)·u(λ,t) (1)

A weight wᵢₙ(λ) is cumulated to a time series signal task u(λ, t) to generate an input signal xᵢₙ(λ, t) to the reservoir 12. This weight wᵢₙ(λ) is a value given in advance prior to performing training of the optical RC and is not be changed through training and testing.

The time series signal task u(λ, t) is generated by passing through the time modulation unit 112 connected to the light source 111 (waveform example A in FIG. 2). The electrical signal for modulation, which is a one-dimensional input signal, is input from a personal computer, a field-programmable gate array (FPGA), or the like. When the personal computer is used, data can be easily rewritten. When the FPGA is used, a high speed electrical signal can be input. For the time modulation unit 112, an optical attenuator such as an LN modulator or an optical amplifier such as a semiconductor optical amplifier can be used. When the optical attenuator is used, it is possible to shorten a computing time because modulation can be performed at high speed. When the optical amplifier is used, it is possible to suppress deterioration of computing capability due to a loss because a signal can be amplified.

The time series signal task u(λ, t) is input to the signal modulation unit 113 and is multiplied by the weight wᵢₙ(λ) for each wavelength (waveform example B in FIG. 2). A wavelength selective switch, a micro electro mechanical system (MEMS), or the like can be used as the signal modulation unit 113. The wavelength selective switch is a device constituted by a diffraction grating and a spatial optical modulator, and is a device capable of modulating a phase and an intensity of each wavelength as desired. When used, the wavelength selective switch can be operated with low power consumption. When the MEMS is used, an extinction ratio can be increased to improve computation performance.

Reservoir Unit

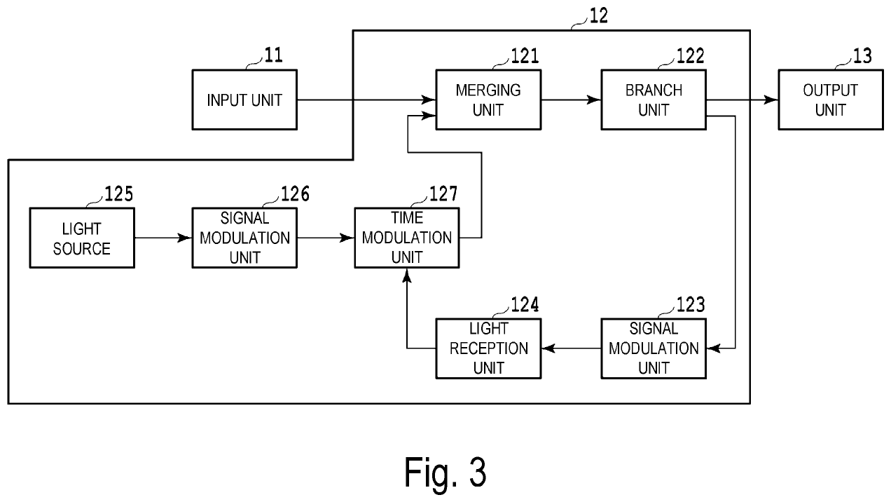

FIG. 3 illustrates a configuration of a reservoir unit of the optical signal processing apparatus according to the present embodiment. The reservoir unit 12 has a function of coupling, at a merging unit 121, a one-dimensional signal propagated from the input unit 11 at time t and a one-dimensional signal circulating around the reservoir unit 12 at the time t−1, and then branching, at a branch unit 122, a part of the processing result to the output unit 13 and the remaining part to the reservoir unit 12. The optical signal from the input unit 11, the optical signal from the multi-wavelength light source, and the electrical signal for modulation are input to the reservoir unit to generate a multi-wavelength optical signal representing various states.

The reservoir unit 12 executes processing indicated in Equation (2).

Math. 2

xᵣₑ(λ,t)=cos²[Σ_{λ}wᵣₑ(λ)·xᵢₙ(λ,t−1)+ϕ]×Ω(λ)+xᵢₙ(λ,t) (2)

The input xᵢₙ(λ, t−1) from the input unit 11 at time t−1 is multiplied by the weight wᵣₑ(λ) and signals in the wavelength direction are cumulated. Modulation of the cos^{t} function is performed on a signal Ω(λ) weighted in the wavelength direction. Finally, the input xᵢₙ(λ, t) from the input unit 11 at time t is added to generate the state xᵣₑ(λ, t) of the reservoir unit 12 at time t. Here, the weight wᵣₑ(λ) and the signal Ω(λ) are values given in advance before performing the training of the optical RC and are not changed through training and testing. Note that φ is a bias in the time modulation unit described below.

The input xᵢₙ(λ, t−1) from the input unit 11 input at time t−1 as a first input to the reservoir unit 12 passes through the merging unit 121 and the branch unit 122 and is input to the signal modulation unit 123. In the signal modulation unit 123, the input is multiplied by the weight wᵣₑ(λ) for each wavelength. A wavelength selective switch, MEMS, or the like can be used as the signal modulation unit 123. When used, the wavelength selective switch can be operated with low power consumption. When the MEMS is used, an extinction ratio can be increased to improve computation performance.

The optical signal that has passed through the signal modulation unit 123 is converted to an electrical signal by a light reception unit 124. Here, rather than providing a light reception unit for each wavelength, a weighted multi-wavelength signal is received by one light reception unit. The electrical signal output from the light reception unit 123 loses information in the wavelength direction, and thus it is possible to perform calculation as if signals in the wavelength direction were added.

On the other hand, a signal light input from a multi-wavelength light source 125 is input to a signal modulation unit 126. As the multi-wavelength light source 125, an ASE light source, a broadband light source, a plurality of single wavelength light sources, or the like can be used. When the ASE light source is used, the light source can be operated relatively stably because only intensity information is used. When the broadband light source is used, an amount of information can be made twice or more because both intensity information and phase information are used. When the plurality of single wavelength light sources are used, intensity information and phase information can be adjusted and used for each wavelength.

In the signal modulation unit 126, the weight Ω(λ) for wavelength is cumulated. The electrical signal for modulation is input from a personal computer, an FPGA, or the like. When the personal computer is used, data can be easily rewritten. When the FPGA is used, a high speed electrical signal can be input. A wavelength selective switch, MEMS, or the like can be used as the signal modulation unit 126. When used, the wavelength selective switch can be operated with low power consumption. When the MEMS is used, an extinction ratio can be increased to improve computation performance.

The weighted signal light Ω(λ) and the electrical signal converted by the light reception unit 124 are input to a time modulation unit 127 to newly generate a modulated signal. As the time modulation unit 127, an optical attenuator such as an LN modulator or an optical amplifier such as a semiconductor optical amplifier can be used. When the optical attenuator is used, it is possible to shorten a computing time because modulation can be performed at high speed. When the optical amplifier is used, it is possible to suppress deterioration of computing capability due to a loss because a signal can be amplified.

The signal light that has passed through the time modulation unit 127 is input to the merging unit 121 as a second input to the reservoir unit 12 and added to the input xᵢₙ(λ, t) from the input unit at time t. As the merging unit 121, a space optical system such as a beam splitter, a fiber optical system such as an optical coupler, or a planar optical system such as a PLC can be used. When the spatial optical system is used, polarization of light is not easily changed, and thus it is possible to increase computation performance. When the fiber optical system is used, configuration of a device can be relatively easily changed by changing optical fiber connection. When the planar optical system is used, loss in an optical component can be suppressed, and thus it is possible to increase computation performance.

The signal light xᵣₑ(λ, t) that has passed through the merging unit 122 is input to the branch unit 122 to be branched into two paths, that is, the reservoir unit 12 and the output unit 13. As the branch unit 122, a space optical system such as a beam splitter, a fiber optical system such as an optical coupler, a planar optical system such as a PLC, or the like can be used. When the spatial optical system is used, polarization of light is not easily changed, and thus it is possible to increase computation performance. When the fiber optical system is used, configuration of a device can be relatively easily changed by changing optical fiber connection. When the planar optical system is used, loss in an optical component can be suppressed, and thus it is possible to increase computation performance.

Output Unit

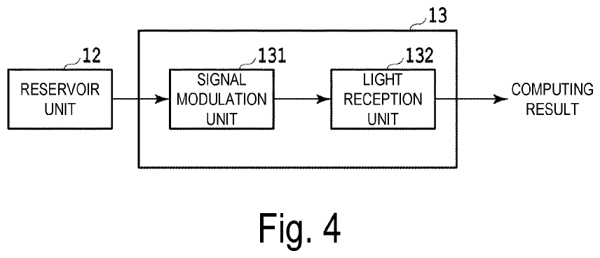

FIG. 4 illustrates a configuration of an output unit of the optical signal processing apparatus according to the present embodiment. The output unit 13 performs product-sum operation on the multi-wavelength signal output from the reservoir unit 12 to generate a one-dimensional output. The output unit 13 includes a signal modulation unit 131 that modulates a multi-wavelength signal output from the reservoir unit 12 with an electrical signal for modulation, and a light reception unit 132 that converts an output of the signal modulation unit 131 into an electrical signal. The electrical signal for modulation is input from a personal computer, an FPGA, or the like. When the personal computer is used, data can be easily rewritten. When the FPGA is used, a high speed electrical signal can be input.

The output unit 13 executes processing indicated in Equation (3).

Math. 3

xₒᵤₜ(t)=Σ_{λ}wₒᵤₜ(λ)·xᵣₑ(λ,t) (3)

The input xᵣₑ(λ, t) from the reservoir unit 12 at time t is multiplied by the weight wₒᵤₜ(λ) and data in the wavelength direction is added to generate an output signal. Here, the weight wₒᵤₜ(λ) is a variable function. The weight wₒᵤₜ(λ) is determined so as to output a desired state T(t) for the state xᵣₑ(λ, t) of the reservoir unit 12, in accordance with Penrose pseudo-inverse matrix. Compared to a backpropagation method, there is no need to repeat update of weight, and thus it is possible to perform computation at high speed. The computation of the weight wₒᵤₜ(λ) is performed by a personal computer, an FPGA, or the like. When the personal computer is used, a state during calculation is easily monitored. When the FPGA is used, computation can be performed at high speed.

At time t, the input signal xᵣₑ(λ, t) from the reservoir unit 12 is input to the signal modulation unit 131. In the signal modulation unit 131, the input is multiplied by the weight wₒᵤₜ(λ) for each wavelength. A wavelength selective switch, MEMS, or the like can be used as the signal modulation unit 131. When used, the wavelength selective switch can be operated with low power consumption. When the MEMS is used, an extinction ratio can be increased to improve computation performance.

The optical signal that has passed through the signal modulation unit 131 is input to the light reception unit 132 and converted into an electrical signal. Here, rather than providing a light reception unit for each wavelength, a weighted multi-wavelength signal is received by one light reception unit. An electrical signal output from the light reception unit 132 loses information in the wavelength direction, and thus it is possible to perform calculation as if signals in the wavelength direction were added.

The computation time of the optical signal processing apparatus of the present embodiment is determined approximately by “modulation speed of light pulse×number of data for task×(number of nodes/number of wavelength multiplexing)”. A value in the parentheses indicates the number of nodes expanded in the time direction. The number of wavelength multiplexing has been 1 for the optical RC in the related art, and thus all nodes have been expanded on the time axis. In the present embodiment, the number of nodes expanded on the time axis can be reduced as the number of multiplexed wavelengths increases. This indicates that a throughput is improved by the reciprocal of the number of multiplexed wavelengths compared to the optical RC in the related art.

As described above, according to the present embodiment, when the optical RC that expands a node in the wavelength direction instead of expanding the node in the time axis direction is made, the throughput of the optical RC can be improved without increasing the number of nodes in the reservoir layer.

### Combination Use of Wavelength Multiplexing and Time Multiplexing

Note that it is also possible to further improve the throughput of the optical RC by expanding a node in the time axis direction at the same time as expanding the node in the wavelength direction even when the number of nodes is greater than the number of wavelengths.

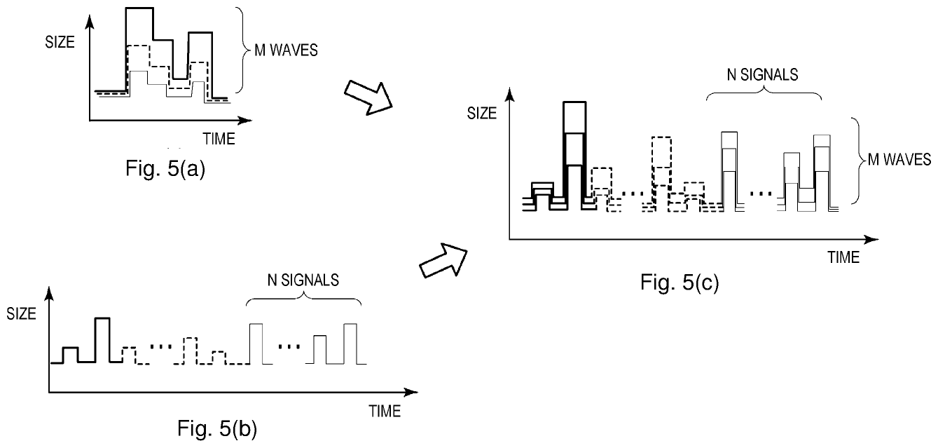

With reference to FIG. 5, an optical signal processing apparatus that uses wavelength multiplexing and time multiplexing in combination is described. FIG. 5(a) illustrates a waveform example B generated in the input unit 11 according to the present embodiment described above, and illustrates that a node has been expanded (M times) in the wavelength direction. FIG. 5(b) illustrates that a node has been expanded (N times) in the time axis direction. A time series signal obtained by stretching a one-dimensional input signal by N times for each pulse in the time axis direction is generated and the stretched time series signal is multiplied by a weight given in advance.

FIG. 5(c) illustrates that a node is expanded in the wavelength direction and the time axis direction, and the expanded result corresponds to the number of nodes of M×N times, which can improve the throughput of the optical RC even when the number of nodes is greater than the number of wavelengths.

### REFERENCE SIGNS LIST

11 Input unit
12 Reservoir unit
13 Output unit
111, 125 Light source
112, 127 Time modulation unit
113, 123, 126, 131 Signal modulation unit
121 Merging unit
122 Branch unit
124, 132 Light reception unit

1. An optical signal processing apparatus for converting an input one-dimensional signal to an optical signal to perform signal processing, the optical signal processing apparatus comprising:
an input unit configured to perform linear processing on the input one-dimensional signal to convert the input one-dimensional signal to an optical signal of multi-wavelength;
a reservoir unit connected to an output of the input unit and configured to perform linear processing and nonlinear processing on the optical signal; and
an output unit connected to an output of the reservoir unit and configured to convert the optical signal to an electrical signal and perform linear processing to output a one-dimensional output.

2. The optical signal processing apparatus according to claim 1, wherein the input unit comprises:
a first multi-wavelength light source;
a first time modulation unit connected to the first multi-wavelength light source and configured to generate a task by the input one-dimensional signal; and
a first signal modulation unit connected to the first time modulation unit and configured to weight an input multi-wavelength optical signal for each wavelength.

3. The optical signal processing apparatus according to claim 2, wherein the first multi-wavelength light source is a light source that multiplexes and outputs light emitted from an amplified spontaneous emission (ASE) light source, a broadband light source, or a plurality of single wavelength light sources.

4. The optical signal processing apparatus according to claim 2, wherein the reservoir unit comprises:
a merging unit configured to couple a light signal propagated from the input unit at a time t and an optical signal circulating around the reservoir unit at a time t−1;
a branch unit configured to branch the coupled optical signal into the reservoir unit and the output unit;
a second signal modulation unit configured to weight an optical signal branched into the reservoir unit at the branch unit for each wavelength;
a first light reception unit connected to the second signal modulation unit and configured to receive and convert the weighted optical signal into an electrical signal;
a second multi-wavelength light source;
a third signal modulation unit connected to the second multi-wavelength light source and configured to weight an input optical signal of multi-wavelength for each wavelength; and
a second time modulation unit configured to modulate the optical signal from the third signal modulation unit in accordance with the electrical signal from the first light reception unit and output the modulated optical signal to the merging unit.

5. The optical signal processing apparatus according to claim 4, wherein the second multi-wavelength light source is a light source that multiplexes and outputs light emitted from an ASE light source, a broadband light source, or a plurality of single wavelength light sources.

6. The optical signal processing apparatus according to claim 4, wherein the output unit comprises:
a fourth signal modulation unit configured to weight an optical signal branched into the output unit in the branch unit for each wavelength; and
a second light reception unit configured to convert the optical signal from the fourth signal modulation unit into an electrical signal.

7. The optical signal processing apparatus according to claim 3, wherein the reservoir unit comprises:
a merging unit configured to couple a light signal propagated from the input unit at a time t and an optical signal circulating around the reservoir unit at a time t−1;
a branch unit configured to branch the coupled optical signal into the reservoir unit and the output unit;
a second signal modulation unit configured to weight an optical signal branched into the reservoir unit at the branch unit for each wavelength;
a first light reception unit connected to the second signal modulation unit and configured to receive and convert the weighted optical signal into an electrical signal;
a second multi-wavelength light source;
a third signal modulation unit connected to the second multi-wavelength light source and configured to weight an input optical signal of multi-wavelength for each wavelength; and
a second time modulation unit configured to modulate the optical signal from the third signal modulation unit in accordance with the electrical signal from the first light reception unit and output the modulated optical signal to the merging unit.

8. The optical signal processing apparatus according to claim 5, wherein the output unit comprises:
a fourth signal modulation unit configured to weight an optical signal branched into the output unit in the branch unit for each wavelength; and
a second light reception unit configured to convert the optical signal from the fourth signal modulation unit into an electrical signal.
